(19) United States
(12) Patent Application Publication
(10) Pub. No.: US 2015/0287109 A1
(43) Pub. Date: Oct. 8, 2015

(54) PERSONALIZABLE ENGAGEMENT PLATFORM

(71) Applicant: Charles L. Dennis, Issaquah, WA (US)

(72) Inventor: Charles L. Dennis, Issaquah, WA (US)

(21) Appl. No.: 14/680,779

(22) Filed: Apr. 7, 2015

Related U.S. Application Data
(60) Provisional application No. 61/976,716, filed on Apr. 8, 2014.

(51) Int. Cl. G06Q 30/02

(52) U.S. Cl. CPC G06Q 30/0281

(57) ABSTRACT

A Personalizable Engagement Platform includes a Customer Module and a Merchant Module for use by participating customers and merchants. Participating customers and merchants are limited to using their respective modules. The Platform is activated when a participating customer is in the proximity of a merchant's place of business. Once activated, participating customers and the merchant are able to exchange selected and personalized information. The Customer Module is preferably in the form of a mobile app that may be downloaded to a mobile device, such as a smartphone, and the Merchant Module is preferable in the form of an app that may be downloaded by a merchant onto their system, which may include, for example, one or more of the following: a server, PC, mobile device(s).

### PRIORITY CLAIM

This patent application claims the benefit of U.S. Provisional Patent Application No. 61/976,716 filed Apr. 8, 2014, the contents of which are hereby incorporated by reference in their entireties.

### COPYRIGHT NOTICE

This disclosure is protected under United States and International Copyright Laws. © 2014 INKLOOD, INC. All Rights Reserved. A portion of the disclosure of this patent document contains material which is subject to copyright protection. The copyright owner has no objection to the facsimile reproduction by anyone of the patent document or the patent disclosure after formal publication by the U.S. Patent Office, as it appears in the U.S. Patent and Trademark Office patent file or records, but otherwise reserves all copyright rights whatsoever.

### FIELD OF THE INVENTION

The present invention relates to generally to merchant and customer interaction and more specifically, to a personalizable engagement platform for merchants and customers.

### BACKGROUND OF THE INVENTION

Merchants regularly face issues with their customer issues. Many times, customers visiting an establishment are loyal, but because they may be anonymous, their loyalty may not acknowledged and rewarded by the merchant. This may cause some clients not to return and cause the merchant to lose potential revenue opportunities. Many times customers lose track of their favorite merchants and products, resulting in lost experience for the customer and lost revenue opportunities for the merchant. Mass marketing is expensive and its effectiveness is questionable. Attracting customers to nearby merchants, even if the potential customer is nearby, is challenging. Accordingly, there is a need for an effective way for merchants to attract and retain customers, and for customers keep track or their favorite merchants, products and services.

### SUMMARY OF THE INVENTION

A Personalizable Engagement Platform includes a Customer Module and a Merchant Module for use by participating customers and merchants. Participating customers and merchants are limited to using their respective modules. The Platform is activated when a participating customer is in the proximity of a merchant's place of business. Once activated, participating customers and the merchant are able to exchange selected and personalized information. The Customer Module is preferably in the form of a mobile app that may be downloaded to a mobile device, such a smartphone, and the Merchant Module is preferable in the form of an app that may be downloaded by a merchant onto their system, which may include, for example, one or more of the following: a server, PC, mobile device(s).

### BRIEF DESCRIPTION OF THE DRAWINGS

Preferred and alternative examples of the present invention are described in detail below with reference to the following drawings:

FIG. 1 is a schematic diagram of a system according to a preferred embodiment of the present invention; and,

FIG. 2 is a schematic diagram of the logical architecture of a system and method according to a preferred embodiment of the present invention.

### DETAILED DESCRIPTION OF THE PREFERRED EMBODIMENT

This patent application describes one or more embodiments of the present invention. It is to be understood that the use of absolute terms, such as “must,” “will,” and the like, as well as specific quantities, is to be construed as being applicable to one or more of such embodiments, but not necessarily to all such embodiments. As such, embodiments of the invention may omit, or include a modification of, one or more features or functionalities described in the context of such absolute terms.

Embodiments of the invention may be operational with numerous general purpose or special purpose computing system environments or configurations. Examples of well known computing systems, environments, and/or configurations that may be suitable for use with the invention include, but are not limited to, personal computers, server computers, hand-held or laptop devices, multiprocessor systems, microprocessor-based systems, set top boxes, programmable consumer electronics, network PCs, minicomputers, mainframe computers, distributed computing environments that include any of the above systems or devices, and the like.

Embodiments of the invention may be described in the general context of computer-executable instructions, such as program modules, being executed by a computer and/or by computer-readable media on which such instructions or modules can be stored. Generally, program modules include routines, programs, objects, components, data structures, etc. that perform particular tasks or implement particular abstract data types. The invention may also be practiced in distributed computing environments where tasks are performed by remote processing devices that are linked through a communications network. In a distributed computing environment, program modules may be located in both local and remote computer storage media including memory storage devices.

Embodiments of the invention may include or be implemented in a variety of computer readable media. Computer readable media can be any available media that can be accessed by a computer and includes both volatile and nonvolatile media, removable and non-removable media. By way of example, and not limitation, computer readable media may comprise computer storage media and communication media. Computer storage media include volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

According to one or more embodiments, the combination of software or computer-executable instructions with a computer-readable medium results in the creation of a machine or apparatus. Similarly, the execution of software or computer-executable instructions by a processing device results in the creation of a machine or apparatus, which may be distinguishable from the processing device, itself, according to an embodiment.

Correspondingly, it is to be understood that a computer-readable medium is transformed by storing software or computer-executable instructions thereon. Likewise, a processing device is transformed in the course of executing software or computer-executable instructions. Additionally, it is to be understood that a first set of data input to a processing device during, or otherwise in association with, the execution of software or computer-executable instructions by the processing device is transformed into a second set of data as a consequence of such execution. This second data set may subsequently be stored, displayed, or otherwise communicated. Such transformation, alluded to in each of the above examples, may be a consequence of, or otherwise involve, the physical alteration of portions of a computer-readable medium. Such transformation, alluded to in each of the above examples, may also be a consequence of, or otherwise involve, the physical alteration of, for example, the states of registers and/or counters associated with a processing device during execution of software or computer-executable instructions by the processing device.

As used herein, a process that is performed “automatically” may mean that the process is performed as a result of machine-executed instructions and does not, other than the establishment of user preferences, require manual effort.

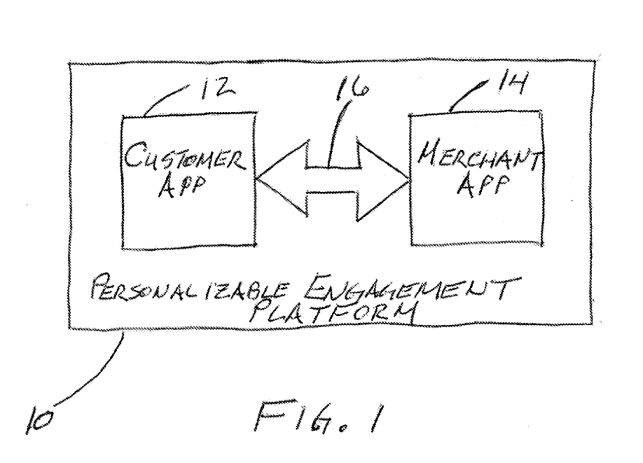

As illustrated in FIG. 1, a Personalizable Engagement Platform (hereinafter “Platform”) 10 according to a preferred embodiment of the present invention includes a Customer Module 12 and a Merchant Module 14 for use by participating customers and merchants. As will be discussed more fully below, Platform 10, including Customer Module 12 and Merchant Module 14 are preferably cloud-based and operate of computing devices of participating customers and merchants. Participating customers and merchants are limited to using their respective modules. When a participating customer is near a merchant's place of business, the Platform is activated and participating customers and the merchant are able to exchange selected and personalized information. The Customer Module is preferably in the form of a mobile app that may be downloaded to a mobile device, such a smartphone. The Merchant Module is preferable in the form of an app that may be downloaded by a merchant onto their system, which may include, for example, one or more of the following: a server, PC, mobile device(s).

According to a preferred embodiment of the present invention, the Platform provided a proximity-based customer engagement solution. The Platform enables consumers (also referred to herein interchangeably as customers) to receive, use, and record information about and within commercial establishments. Examples of these commercial establishments include, but are not limited to stores, banks, restaurants, bars, wineries, wine tasting rooms, coffee shops and athletic clubs. The Platform enables merchants to move from mass marketing to mass personalization for current and potential customers. It also provides an affordable and easy to use hospitality solution to assist merchants in helping with customer marketing and relationship management.

For ease of understanding and illustration purposes, a preferred embodiment is described below in the context of wineries or bars and their customers. As discussed previously, however, it is understood that the present invention may be practiced and implemented in numerous other environments.

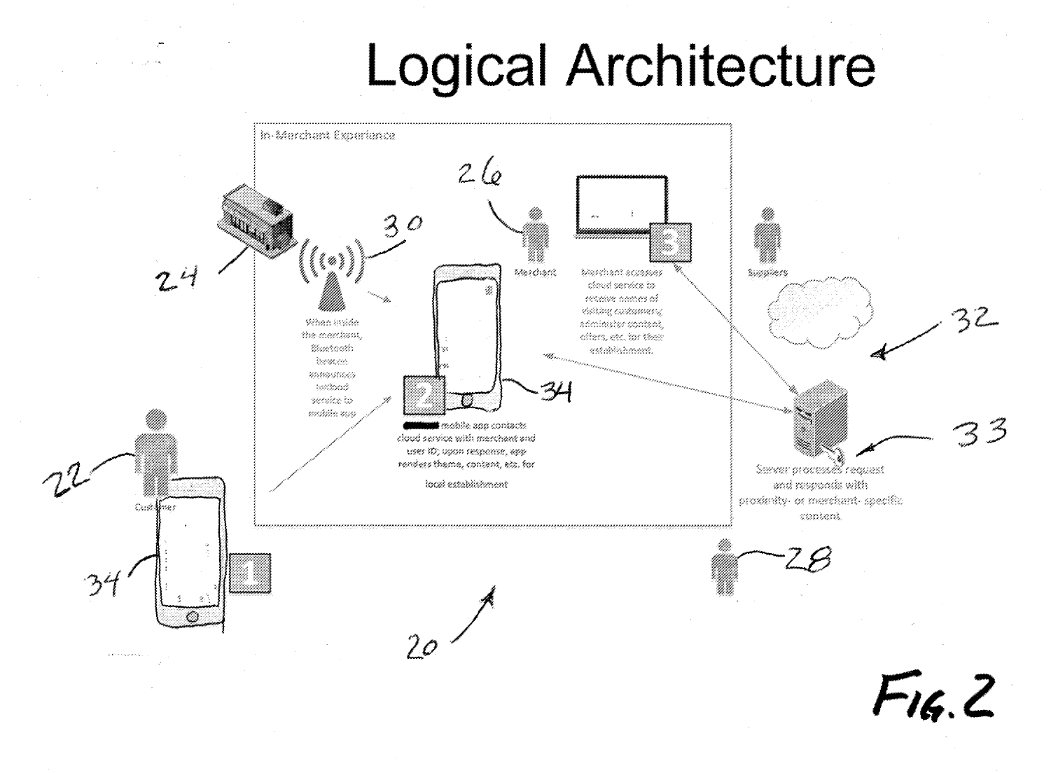

As illustrated in FIG. 2, when a participating customer 22 approaches a merchant location or upon entering the merchant location 24, the Platform 10 is adapted or transformed into a specific merchant application and engagement tool 20. The participating merchant 26 is provided with the customer's name and other customer info via the Merchant Module (FIG. 1), which also allows for personalization of merchant's content to be delivered to the customer 22. The Platform 10 allows consumers 22, via Customer Module 12, to record their merchant-related information, such as likes and dislikes about products and services, and to save the information for future reference, such as during repeat visits to and later purchasing from merchant 26. Customer 22 may share comments about his/her experience via social media generally, and via social media with other participating customers 28 in or near the merchant location 28.

As further illustrated in FIG. 2, an aspect of one embodiment of the present invention is the utilization of mobile location detection or proximity technology 30 installed at the merchant's premises 24. Bluetooth® Low Energy (BLE) is just one example of such location detection technology used in commercial establishments. Another aspect of one embodiment is cloud-based computing and storage capability 32 as preferably accessed by a web-based service and mobile app, such as Platform 10. Yet another aspect of an embodiment is customer's mobile device 34 that contains the necessary software for receiving wireless beacon-like signals, such as, for example, Bluetooth 4.0. Still another aspect of an embodiment includes a universal mobile device (such as, for example, a smartphone or tablet) that preferable connects to the Internet via any means available, such as wireless carrier data channel, WI-A, etc.

The participating merchant preferable has already installed mobile proximity hardware 30 and downloads Merchant Module 14, while the customer downloads the Customer module 12 to their mobile device 34. The Platform preferably works with the mobile device 34 when wireless signal from the BLE device 30 is received and communicates via the mobile device's data and Internet connection to the cloud-based platform 32.

As previously discussed, merchants utilize location-sensing technology, such as Bluetooth® beacons, at their locations for data, communication and monitoring purposes. When a participating customer's smartphone is in proximity of a merchant's beacon, identifying information about the customer is provided. Preferably, the identifying information was previously selected by the customer during setup and download of the Customer Module 12. For example, if the customer 22 chose at signup to provide his/her name, the name would be made available to the Platform app 10 and the merchant 26 when the customer 22 was near a beacon 30. The Platform app 10 may provide a unique customer identifier to the participating customer 22 when the customer does not provide identifying information.

The Platform app 10 processes the customer identity information for sending special offers and personalizing the customers' screen data. The merchant 26 may set parameters to determine when he/she is to be notified of the presence of a particular participating customer 22. For example, the merchant 26 may wish to be notified when a loyal customer is visiting the establishment. Preferably, the merchant 26 receives immediate comments from participating customers 22 while the customers are present, thereby permitting the merchant to act on the customer's comment(s) while the customer is still at the merchant's location.

The Merchant Module 14 preferably provides the merchant with access to history, usage, and comments data of its participating customers. For example, if a participating customer sent a food complaint to the merchant during a previous visit, the merchant may be reminded of that customer experience so that the merchant is able to provide a better experience to the customer during a subsequent visit.

Merchant 26 preferably has ability to develop and deliver dynamic messages and offers to participating customers 22 that are at the merchant's location 24. For example, if a local sports team scores and takes the lead in a game, the merchant 26 may send all participating customers 22, 28 a special appetizer and drink special. As another example, the merchant may select loyal customer names for sending thank you messages when the customer leaves the proximity of the beacon 30 (i.e., leaves the merchant's location 24).

According to yet another aspect of the present invention, the Platform includes social media/networking capability, which allows a participating customer 22, that is, one who has opted-in to use the Platform, to engage with other participating customers 28 in a participating merchant location 24. For example, a participating customer 22 may chat with other customers 28, buy other customers 28 a drink, play a game against other customers 28, post a message to the merchant's online chat board and find out which customers 28 are currently in the establishment 24.

In one embodiment of the present invention, a computing device (e.g., desktop computer; laptop/tablet, etc.) provides access to a universal web-based application for both the customers and merchants (shown generally at 332 in FIG. 2). Service web site password protection 33 may be implemented for merchant and customer protection and to permit access, development, and management of merchant and personal customer profiles.

A participating merchant may wish to offer discounts on beverages and food certain times of the day in attempts to lure to their merchant location patrons (customers) who are interested in taking advantage of such discounts.

Platform 10 preferably provides real time, or near-real time, information to merchant 26 via Merchant Module 14. The following are examples of the types of information that may be presented to the merchant 26: the names and profiles of participating customers currently visiting the merchant, the current merchant information being presented on customers' mobile apps, a history of items purchased and favorite items identified by customer, and messages received from customers. It is understood that the forgoing list of information is not limited to the examples given and that other types of information may be presented and accessed by the merchant 26.

As previously discussed, participating customer 22 receives information from the merchant 26 and may provide information and/or communicate with the merchant or other participating customers 26. A participating customer may receive an offer from a merchant on a first screen of his/her mobile device when in proximity with the merchant. A merchant offer is preferably personalized for a customer based on that customer's history of (for example) items purchased, time of day, day of week, and the customer's profile. By way of example, the first time, or first several times, a customer receives a merchant offer it may not be personalized, because no prior history has been obtained.

In accordance with the preferred embodiment, a main or home area of the Platform app includes a menu of other screens containing participating merchant information and other information of interest to customers. Home screen information on a customer mobile device is accessible outside of the proximity of a participating merchant and may be accessed by selecting the Platform app on the customer's mobile device. Also, the home screen information for a particular merchant is accessible when the customer is at that particular merchant's location. Screens may include history of merchants visited, favorite food and beverages of merchants visited, favorite friends by merchant, saved merchant events, profile, etc. As previously mentioned, saving information is achieved, for example, by selecting the thumbs up button next to an item on one of the merchants' screens. A profile screen offers the customer the opportunity to record food and beverage preferences. The home screen may also be used to search for participating merchants and can be used to look up special offers for a particular merchant.

A welcome screen on the participating customer's mobile device 34 preferably includes a menu of other available screens. The menu or welcome screen may include other merchant offers, including, for example, beverages, happy hour specials, events, names of participating customers currently at the merchant's location, games between customers, favorite menu items, favorite friends, comments for the merchant and messaging with other participating customers and on a merchant chat board or other site that may permit further interaction between participating customers and the merchant. Preferably, a thumbs up button is located on the screen next to an item/choice, and once tapped, that item/choice is saved for future reference. Saved items preferably appear on merchant and customer screens. An Order button allows customers to select an item to order while at a participating merchant.

Participating customers may obtain points when they are in the proximity of a participating merchant's beacon. Limitations may be selected and imposed by the merchant. For example, a customer may be allowed to visit a merchant only once a day or only within a set number of hours, and still receive points to be credited to her/his account. As a way to further encourage customer loyalty and satisfaction and merchant revenue, points may be converted by customers for other goods/services from that merchant. For example, a merchant may permit a customer to convert accumulated points into a gift certificate.

Similarly, and in accordance with an embodiment of the invention, a participating merchant may exchange information with a participating customer by accessing the Merchant Module 14 of the Platform app 10. The merchant 26 selects the information to be inserted onto particular screens and selects which screens to populate. For example, screens for wine merchants will likely be different than screens for bars and restaurants. The merchant has access to customer profile preference information, to assist in delivering personalized special offers. Merchants may also update information in the Merchant Module 14.

Certain capabilities and features of Platform app 10 are described below with respect to wineries and their customers. It is to be understood that these particular capabilities and features are for illustrative purposes only and are not to be considered an exclusive list. Likewise, as discussed previously, the Platform 10 is suitable in environments other than wineries.

When a participating customer is in the proximity of a participating merchant (a winery in this example) and selects the Platform 10, the app will launch and a series of screens will be available on the customer's mobile device.

Arriving at the winery tasting room, the home screen preferably reflects the winery's look and content.

A menu on the home screen may include the following selections:
CURRENT LIST of wines being poured and tasted, including wine notes
SHARING via social media
SCHEDULE of Events
WINE CLUB member benefits
HISTORY of Wineries visited.

Selecting CURRENT LIST on the home screen offers the following choices:
List of wines being tasted presented with tasting notes
Buttons for: Fair; Good; Very good; Excellent; and Favorite
Touch field to make selection
Box is presented under wine names for typing comments
Save button is touched to save selections and comments
Can swish back to prior screen of list of wines being tasted or swish forward to fourth screen; or can touch home button to get back to home screen.

Selecting SHARRING on the home screen offers the following choices:
Method for sharing recommended wine and/or winery via social media
Facebook sharing: touch Facebook button and follow link for personal FB account and sharing
Participant sharing: Participating customers receive information (that have consented to receive such information sharing)
Swish back to prior screens or swish forward to fifth screen; or can touch home screen button to get back to home screen.

Selecting SCHEDULE on the home screen offers the following choices:
List of scheduled events by date presented
Swish back to prior screens or forward to sixth screen; or can touch home screen button to get back to home screen.

Selecting WINE CLUB on the home screen offers the following choices:
Discounts on purchases information is presented
Special offers presented
Swish back to prior screens or forward to seventh screen; or can touch home screen button to get back to home screen.

Selecting HISTORY on the home screen offers the following choices:
Chronological order of all wineries visited with buttons showing:
   Today
   Last 10 days
   Last year
   Complete history
Upon touching a winery name, relevant data presented of recorded feedback, comments, and favorite wine tasted previously
Swish back to prior screens as desired; or hit home screen button to get back to home screen.

Additional capabilities and features the mobile app may include:
Ability to know some or all of the participating customers currently present at a winery tasting room (when consented by users)
Messaging anonymously or publicly to one or all participating customers
Ability to use social media to invite friends to join at a winery; and when friends join the customer inviting receives a special offer from the merchant (winery)
Ability to send merchant a message on any comments regarding tasting room experience
Send a personalized message to a customer when he/she arrives and leaves
Receive personalized wine offering based on profiled preferences and purchase history

The merchant app may provide the participating merchant with the following and participating customer information:
List of participating customers currently at winery tasting room
Notification of when a wine club member and a loyal customer is present
Editing wine tasting menu items presented on customers' app
Editing home page screen wall paper
Editing other screens' wall paper
Database of customer comments
History of customer visitations
History of menu item buttons touched by customers
Capability for recording information on items purchased by customer in specific customer profile
Ability to view customers' history of wineries visited
Ability to view what customers' have shared via social media
Ability to manually or automatically send a welcome or good-bye greeting to a customer
Ability to view participating customer profile and preferences information.

While the preferred embodiment of the preferred embodiment of its invention has been illustrated and described, as noted above, many changes can be made without departing from the spirit and scope of the invention. Accordingly, the scope of the invention is not limited by the disclosure of the preferred embodiment. Instead, the invention should be determined entirely by reference to the claims.

The embodiments of the invention in which an exclusive property or privilege is claimed are defined as follows:

1. A personalizable engagement platform device capable of being activated comprising:
a Customer Module accessible by a participating customer; and,
a Merchant Module accessible by a participating merchant, wherein the Customer Module and Merchant Module are activated when the customer is in the proximity of the merchant.

2. The device of claim 1, wherein the Customer Module and the Merchant Module are downloadable applications.

3. The device of claim 2 wherein the customers and merchants are limited to using their respective modules.

4. A system for a personalizable engagement platform, comprising:
a service website configured to create a personal profile;
a transmitter located at a first location, wherein the first transmitter is configured to transmit an identifying signal;
a cloud-based platform having a database of personal profiles each corresponding to an identifying signal; wherein the cloud-based platform is configured to store the personal profiles created from the service website and transmit a first wireless signal upon receipt of a second wireless signal; and,
a receiver configured to display the personal profile, wherein the receiver is configured to receive the identifying signal from the first transmitter and a first wireless signal from the cloud-based platform and transmit a second wireless signal to the cloud-based platform in response thereto.

5. A method for a personalizable engagement platform, comprising the steps of:
transmitting an identifying signal from a transmitter;
receiving the identifying signal by a receiver;
transmitting a first wireless signal from the receiver to a cloud-based platform;
receiving a second wireless signal by the receiver; and
displaying the second wireless signal.
